(19) United States
(12) Patent Application Publication
(10) Pub. No.: US 2013/0042281 A1
(43) Pub. Date: Feb. 14, 2013

(54) Distribution of Over-the-Air Television Content to Remote Display Devices

(71) Applicants: Pater Marcus Buff, Garner, NC (US); Robert Michael Barts, Raleigh, NC (US)

(72) Inventors: Pater Marcus Buff, Garner, NC (US); Robert Michael Barts, Raleigh, NC (US)

(73) Assignee: GREENWAVE SCIENTIFIC, INC., Raleigh, NC (US)

(21) Appl. No.: 13/569,242

(22) Filed: Aug. 8, 2012

Related U.S. Application Data
(60) Provisional application No. 61/574,708, filed on Aug. 9, 2011.

(51) Int. Cl. H04N 21/61

(52) U.S. Cl. 725/81

(57) ABSTRACT

A system for the distribution of over-the-air (OTA) television content for remote display includes an OTA antenna, a wireless antenna transceiver connected to the OTA antenna for receipt of OTA television signals via the OTA antenna, as set-top box receiver (STBR), and a television receiver connected to the set-top box receiver and adapted to receive video data therefrom. The wireless antenna transceiver includes a first wireless access point for transmission of television content signals, derived from the OTA television signals, via wireless link, and the STBR includes a second wireless access point for receipt of television content signals via wireless link. The STBR receives the television content signals directly from the wireless antenna transceiver or from an intermediate wireless router. The wireless router may also distribute the OTA content to other display devices. Power-line networking may alternatively be used instead of wireless links.

### CROSS-REFERENCE TO RELATED APPLICATION

The present application is a U.S. nonprovisional patent application of, and claims priority under 35 U.S.C. §119(e) to, U.S. provisional patent application Ser. No. 61/574,708, filed Aug. 9, 2011, which provisional patent application is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

1. Field of the Present Invention

The present invention relates generally to antenna and transceivers, and more particularly, to antennas and transceivers connected to a local area network either by a wireless (radio) link or by a signal-over-power-line networking for reception and viewing of Over-the-Air (OTA) television broadcasts.

2. Background

Television viewing habits are undergoing enormous changes due to the increase of rich internet video content and increasing network bandwidths, digital video recording (DVR) and time-shifting devices, economic instabilities and the transition from analog to digital broadcasting. Users are finding greater video offerings from online video distributors (OVDs) or “over-the-top” (OTT) services delivered by network connections such as the internet. The exceptional high definition digital quality of over-the-air (OTA) broadcasts provides users with traditional network and local TV programming.

OTT streaming has been around for a while, but its popularity has exploded in recent years due to increased wireless network bandwidths sufficient enough to stream high quality content to any number of digital devices, ranging from smartphones, tablets, netbooks, laptops and more recently, televisions. Smart TVs, or internet connected televisions, are available and offer the capability to stream OTT content. However, although OTT streaming is gaining popularity, viewers also desire access to over-the-air broadcasting to obtain free local and network programming that is not available online.

As used herein, Over-the-Air (OTA) refers to the terrestrial broadcasts of TV stations in a local area. These local channels, which are also usually available on cable or satellite, provide local news, sports and major network shows. Most of these are the network affiliates of the large national networks, but may also include smaller independent stations.

Local TV stations have always broadcast their programs over the air for free. Prior to 2009, almost all of the TV stations broadcast analog (NTSC) TV signals. Analog TV has been around and essentially unchanged (with the exception of the modification to NTSC to allow color broadcasting) since the 1940's. Prior to the widespread availability of community and cable TV, everyone had to have an individual antenna to watch TV. Whether it was the old indoor ‘rabbit ears’ or a large rotatable outdoor antenna mounted on the roof, watching TV usually required adjusting the antenna for each channel in order to get good reception. The quality of reception varied greatly. Snowy, fuzzy pictures were often the norm. Multipath signals caused ‘ghosting’ where multiple versions of the picture were seen.

In 2009, the Federal Communication Commission (FCC) mandated that all U.S. broadcast stations change over to digital (ATSC) TV broadcasts, and other countries are expected to make the transition from analog to digital networks as well. ATSC allows for high definition television (HDTV) broadcasts which offers much higher resolution TV images as compared to the old analog TV system. High resolution, clear pictures and high quality stereo audio make HDTV a significant improvement over the old analog TV signals.

In addition to higher quality images and sound, digital broadcasting also offers significant improvements in OTA reception. With digital broadcasts, signal quality is essentially independent of signal strength once a minimum signal strength threshold has been crossed. All that is needed is a digital-ready TV (a television with a digital-compatible tuner such as ATSC) and an OTA antenna.

Conventionally, to receive OTA broadcast signals, an antenna is connected directly to the television. To receive digital OTA broadcasts, the television must also include a digital tuner. The specific digital tuner technology varies in different parts of the world, with ATSC digital tuners being utilized in North America. DVB/T digital tuners in Europe, parts of Asia, and Australia, ISDB-T digital tuners being utilized in South America, and DMB-T/H digital tuners being utilized in most of Asia.

In another development, systems exist that permit users to place digital OTA content onto their wired local area networks. FIG. 1 is a block diagram illustrating one such system known as HDHomeRun (offered by SiliconDust USA of Pleasanton, Calif.) in which a network attached digital TV tuner enables viewers to watch and record digital and high-definition (HD) television content from any computer within a small building via a local area network (LAN). By connecting an external television antenna, these products enable the user to stream over-the-air content onto the LAN in a wired fashion for viewing with LAN connected devices such as laptop or desktop computers, netbooks, tablets, and smartphones.

Unfortunately, such systems lack wireless communication capabilities and depend instead upon the physical connectivity of the LAN, thereby suffering from all of the problems or disadvantages traditionally associated with wired networks. Although a wireless router may be connected to the LAN, and wireless links used to connect such router to other devices, the over-the-air antenna must still be physically connected to the wireless router via a wired connection from the networked tuner. Furthermore, such systems lack the ability to wirelessly connect an OTA antenna more directly to a traditional television. Thus, a need exists for new solutions providing high quality OTA content delivered to various types of remotely-located display devices without relying upon a wired LAN and the like for the distribution of the content.

### SUMMARY OF THE PRESENT INVENTION

Broadly defined, the present invention according to one aspect is a system for the distribution of over-the-air (OTA) television content to a remotely-located set-top box receiver for display on a television receiver, including: an OTA antenna; a wireless antenna transceiver connected to the OTA antenna for receipt of OTA television signals via the OTA antenna, the wireless antenna transceiver including a first wireless access point for transmission of television content signals, derived from the OTA television signals, via wireless link a set-top box receiver having a second wireless access point for reception of television content signals via wireless link; and a television receiver connected to the set-top box receiver and adapted to receive video data therefrom based on the television signals received by the set-top box receiver via wireless link.

In a feature of this aspect, the wireless link over which the first wireless access point transmits television content signals is the same wireless link with which the second wireless access point receives television content signals.

In another feature of this aspect, the system further includes a wireless router, wherein the wireless link over which the first wireless access point transmits television content signals is a first wireless link, wherein the wireless router receives the television content signals transmitted by the first the wireless access point via the first wireless link, and wherein the second wireless access point receives television content signals via a second wireless link established between the second wireless access point and the wireless router.

In another feature of this aspect, the wireless antenna transceiver further includes a tuner, adapted to tune analog or digital TV broadcast signals received, over-the-air via the OTA antenna, and a control system, adapted to process a compressed video signal output from the tuner and to prepare it for transmission by the first wireless access point. In further features, the processing of the compressed video signal output by the control system includes further compression thereof; and/or the processing of the compressed video signal output by the control system includes packetizing thereof.

In another feature of this aspect, the first wireless access point transmits the television content signals using a wireless communications protocol such as an 802.xx protocol connection.

In another feature of this aspect, the second wireless access point receives the television content signals using an 802.xx protocol communications link.

In another feature of this aspect, the set-top box receiver further includes a transmitter, adapted to provide the video data to the television receiver, and a control system, adapted to uncompress the television content signals received by the second wireless access point.

In another feature of this aspect, the television receiver is located in a room in a building, and wherein the wireless antenna transceiver is not located in the same room.

In another feature of this aspect, the set-top box receiver is located in a room in a building, and wherein the wireless antenna transceiver is not located in the same room.

In another feature of this aspect, the wireless antenna transceiver is located adjacent the OTA antenna.

Broadly defined, the present invention according to another aspect is a system for the distribution of over-the-air (OTA) television content to a remotely-located display device, including: an OTA antenna; a wireless antenna transceiver connected to the OTA antenna for receipt of OTA television signals via the OTA antenna, the wireless antenna transceiver including a first wireless access point for transmission of television content signals, derived from the OTA television signals, via a first wireless link; a wireless router for receipt of the television content signals from the wireless access point via the first wireless link and for retransmission of the television content signals via a second wireless link; and a display device adapted to receive the television content signals via, the second wireless link.

In a feature of this aspect, the display device is adapted to receive the video data from the wireless antenna receiver in a compressed format and to convert the video data to an uncompressed format for display.

In another feature of this aspect, the display device is a personal computer, a tablet computer, or a smartphone.

In another feature of this aspect, the wireless router is located in a room in a building, and wherein the wireless antenna transceiver is not located in the same room.

In another feature of this aspect, the wireless antenna transceiver is located adjacent the OTA antenna.

Broadly defined, the present invention according to another aspect is a system for the distribution of over-the-air (OTA) television content to a remotely-located over-the-top set-top box for display on a television receiver, including: an OTA antenna; a wireless antenna transceiver connected to the OTA antenna for receipt of OTA television signals via the OTA antenna, the wireless antenna transceiver including a first wireless access point for transmission of television content signals, derived from the OTA television signals, via wireless link: an over-the-top set-top box having a second wireless access point for receipt of television content signals via wireless link; and a television receiver connected to the over-the-top set-top box and adapted to receive video data therefrom based on the television signals received by the over-the-top set-top box via wireless link.

In a feature of this aspect, the wireless link over which the first wireless access point transmits television content signals is the same wireless link with which the second wireless access point receives television content signals.

In another feature of this aspect, the system further includes a wireless router, wherein the wireless link over which the first wireless access point transmits television content signals is a first wireless link, wherein the wireless router receives the television content signals transmitted by the first the wireless access point via the first wireless link, and wherein the second wireless access point receives television content signals via a second wireless link established between the second wireless access point and the wireless router.

In another feature of this aspect, the wireless antenna transceiver further includes a tuner, adapted to tune analog, or digital TV broadcast signals received over-the-air via the OTA antenna, and a control system, adapted to process a compressed video signal output from the tuner and to prepare it for transmission by the first wireless access point. In further features, the processing of the compressed video signal output by the control system includes further compression thereof; and/or the processing of the compressed video signal output by the control system includes packetizing thereof.

In another feature of this aspect, the first wireless access point transmits the television content signals using an 802.xx protocol.

In another feature of this aspect, the second wireless access point receives the television content signals using an 802.xx protocol.

In another feature of this aspect, the over-the-top set-top box is adapted to provide the television content signals, received by the second wireless access point, as a content channel that is selectable by a user of the over-the-top set-top box, and to provide the video data to the television receiver when the content channel is selected.

In another feature of this aspect, the television receiver is located in a room in a building, and wherein the wireless antenna transceiver is not located in the room.

In another feature of this aspect, the over-the-top set-top box is located in a room in a building, and wherein the wireless antenna transceiver is not located in the room.

In another feature of this aspect, the wireless antenna, transceiver is located adjacent the OTA antenna.

Broadly defined, the present invention according to another aspect is a system for the distribution of over-the-air (OTA) television content to a remotely-located set-top box receiver for display on a television receiver, including: an OTA antenna; a wireless antenna transceiver connected to the OTA antenna for receipt of OTA television signals via the OTA antenna, the wireless antenna transceiver including a first power-line networking device for transmission of television content signals, derived from the OTA television signals, via power-line networking; a set-top box receiver having a second power-line networking device for receipt of television content signals via power-line networking; and a television receiver connected to the set-top box receiver and adapted to receive video data therefrom based on the television signals received by the set-top box receiver via power-line networking.

In a feature of this aspect, the wireless antenna transceiver further includes a tuner, adapted to tune analog or digital TV broadcast signals received over-the-air via the OTA antenna, and a control system, adapted to process a compressed video signal output from the tuner and to prepare it for transmission by the first power-line networking device.

In another feature of this aspect, the processing of the compressed video signal output by the control system includes further compression thereof.

In another feature of this aspect, the processing of the compressed video signal output by the control system includes packetizing thereof.

In another feature of this aspect, the set-top box receiver further includes a transmitter, adapted to provide the video data to the television receiver, and a control system, adapted to uncompress the television content signals received by the second power-line networking device.

In another feature of this aspect, the television receiver is located in a room in a building, and wherein the wireless antenna transceiver is not located in the room.

In another feature of this aspect, the set-top box receiver is located in a room in a building, and wherein the wireless antenna transceiver is not located in the room.

In another feature of this aspect, the wireless antenna transceiver is located adjacent the OTA antenna.

Broadly defined, the present invention according to another aspect is a system for the distribution of over-the-air (OTA) television content to a remotely-located wireless antenna receiver for display on a display device, including: an OTA antenna; a wireless antenna transceiver connected to the OTA antenna for receipt of OTA television signals via the OTA antenna, the wireless antenna transceiver including a first wireless access point for transmission of television content signals, derived from the OTA television signals, via wireless link; a wireless antenna receiver having a second wireless access point for receipt of television content signals via the wireless link; and a display device connected to the wireless antenna receiver and adapted to receive video data therefrom based on the television signals received by the wireless antenna receiver via wireless link.

In a feature of this aspect, the display device is adapted to receive the video data from the wireless antenna receiver in a compressed format and to convert the video data to an uncompressed format for display.

In another feature of this aspect, the wireless antenna transceiver further includes a tuner, adapted to tune analog or digital TV broadcast signals received over-the-air via the OTA antenna, and a control system, adapted to process a compressed video signal output from the tuner and to prepare it for transmission by the first wireless access point. In further features, the processing of the compressed video signal output by the control system includes further compression thereof; and/or the processing of the compressed video signal output by the control system includes packetizing thereof.

In another feature of this aspect, the first wireless access point transmits the television content signals using an 802.xx protocol.

In another feature of this aspect, the second wireless access point receives the television content signals using an 802.xx protocol.

In another feature of this aspect, the set-top box receiver further includes a control system, adapted to receive the television content signals received by the second wireless access point and to provide them to the display device.

In another feature of this aspect, the display device is located in a room in a building, and wherein the wireless antenna transceiver is not located, in the room.

In another feature of this aspect, the wireless antenna receiver is located in a room in a building, and wherein the wireless antenna transceiver is not located in the room.

In another feature of this aspect, the wireless antenna transceiver is located adjacent the OTA antenna.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a block diagram illustrating a prior art system;

FIG. 2 is a block diagram illustrating a system for the distribution of OTA television content to a remotely-located set-top box receiver for display on a television receiver in accordance with a first preferred embodiment of the present invention;

FIG. 3 is a block diagram illustrating a system for the distribution of OTA television content to a remotely-located over-the-top set-top box for display on a television receiver in accordance with a second preferred embodiment of the present invention;

FIG, 4 is a block diagram illustrating a system for the distribution of OTA television content to a remotely-located set-top box receiver for display on a television receiver in accordance with a third preferred embodiment of the present invention;

FIG. 5 is a block diagram illustrating a system for the distribution of OTA television content to a remotely-located wireless antenna receiver for display on a display device in accordance with a fourth preferred embodiment of the present invention; and

FIG. 5 is a block diagram illustrating a system for the distribution of OTA television content to a remotely-located set-top box receiver for display on a television or other display device in accordance with a fifth preferred embodiment of the present invention.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fill within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined, by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may he shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still filling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ⊂6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, one or more preferred embodiments of the present invention are next described. The following description of one or more preferred embodiments is merely exemplary in nature and is in no way intended to limit the invention, its implementations, or uses.

In accordance with one or more preferred embodiments of the present invention, a digital television antenna system includes a Wireless Antenna Transceiver (WAT) and a wireless link providing content to one or more display devices. The Wireless Antenna Transceiver tunes and receives the analog and/or digital signals from either Over-the-Air (Terrestrial) or cable sources and places the content onto the wireless local area network (WLAN) or other wireless link. The WAT includes one or more analog/digital television broadcast tuners, a control system and a Wireless Access Point (WAP). Each of these is described generally below.

The single or multiple digital television broadcast tuners provide tuning capabilities to tune to a variety of broadcast standards including analog (NTSC/PAL/SECAM) and digital (ATSC, DVB, ISDB, DOCSIS) sources from either terrestrial or cable networks. The tuner block of the WAT includes a demodulator for each of the desired signal standards, thus comprising a complete radio frequency (RF) front-end integrated digital tuner.

The control system, which in some embodiments may be implemented in a System on a Chip (SoC) format, provides all elements needed for data processing, including, a microcontroller/microprocessor core, necessary memory blocks, timing sources, peripherals and interfaces, and power management circuits.

The Wireless Access Point (WAP), which in at least some embodiments is an 802.1xx-compliant access point, provides all elements needed to place the digital video signal onto a WLAN. This can be a direct peer-to-peer (P2P) connection between the WAT and an appropriate receiver such as a television Set-Top Box Receiver (STBR), or a network connection to a wireless router, making the digital video stream available to all devices connected to the network. It is noted that many common wireless routers are conventional routers that have a fixed number of network ports for wired network connections as well as a wireless transceiver for wireless network connections.

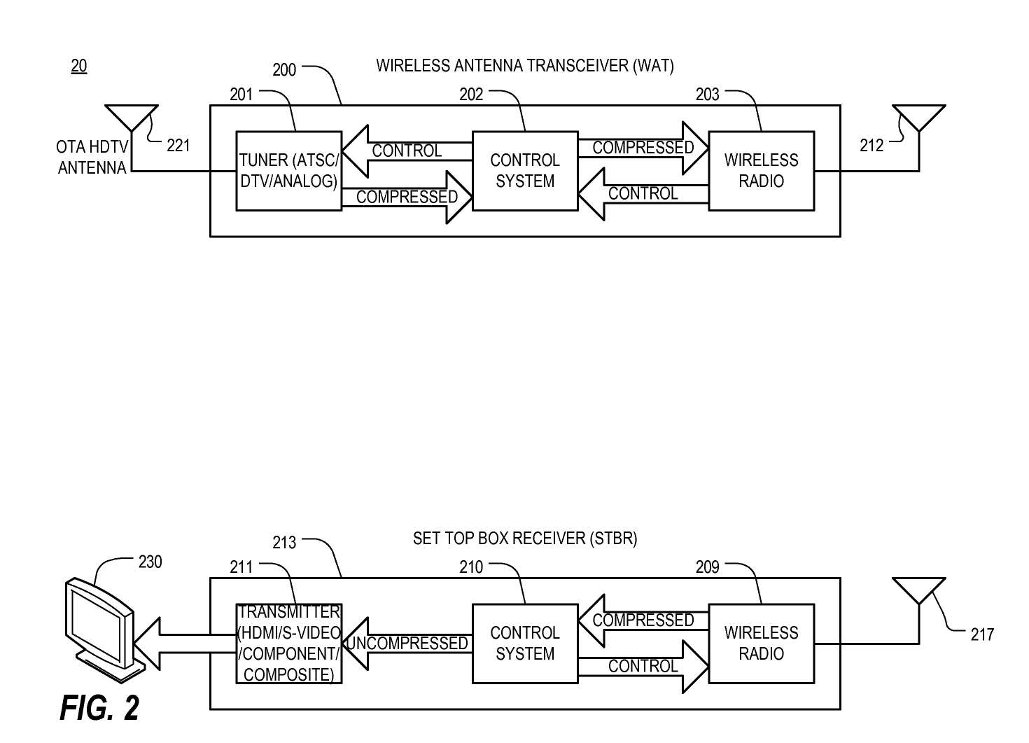

FIG. 2 is a block diagram illustrating a system 20 for the distribution of OTA television content to a remotely-located set-top box receiver 213 for display on a television receiver 230 in accordance with a first preferred embodiment of the present invention. In the system 20 illustrated in FIG. 2, a Wireless Antenna Transceiver (WAT) 200 communicates with a Set-Top Box Receiver (STBR) 213 over a wireless link. As with other systems described herein, the Wireless Antenna Transceiver (WAT) 200 includes one or more tuners 201 capable of tuning analog or digital TV broadcast signals received over-the-air via an OTA television antenna 221. The tuners 201 demodulate the OTA signal and provide a compressed video signal output. The video signals from the tuners 201 are processed by the control system 202 which is responsible for controlling the tuners 201 as well as processing the compressed video (possibly including additional compression) to prepare it for transmission, over a wireless link, by the Wireless Access Point (wireless radio 203 and antenna 212). This may include compressing the video and packetizing the data among other functions. The video data is transmitted by the Wireless Access Point which may utilize any type or number of RF protocols and formats. These protocols and formats may include standard protocols such as 802.xx and ultra-wide band (UWB), but may also include proprietary formats and protocols.

From the Wireless Access Point of the Wireless Antenna Transceiver (WAT) 200, the video data may be routed via wireless link to a Set Top Box Receiver (STBR) 213 that is connected to a television set 230. In at least some embodiments, the STBR 213 includes a Wireless Access Point (antenna 217 and wireless radio 209), a control system 210, and an appropriate transmitter 211. The Wireless Access Point feeds video data received via wireless link from the wireless router 204 (or in some cases, directly from the WAT 200) to the control system 210, which uncompresses the video data and reassembles it, reversing the functions of the control system 202 in the WAT 200. The uncompressed video is then fed to an appropriate transmitter 211 that provides the video and audio data in any of a variety of data formats and interface types appropriate for the television set 208 to display it. One preferred format is MPEG-4, but others may likewise be utilized. Interface types may include HDMI, component audio and video, S-video, composite video, and the like.

It will be appreciated that the exact location where the video stream is uncompressed to generate an MPEG-4 or other data stream may be somewhat dependent on the system architecture, but that generally, the video preferably stays compressed until a location as close to the display device as possible.

In at least some embodiments, the STBR 213 also provides a user interface for controlling the tuner 201 in the WAT 200. Using a wireless or optical remote control device (not shown), commands to the tuner 201 are received by the control system 210 of the STBR 213 and control messages are then passed back to the WAT via the same wireless network used to receive the digital video stream. In at least some embodiments, control functions such as channel scanning and channel changes are provided that are specific to the tuner 201 in the WAT 200. In this way, control of the WAT 200 may be effectuated via the STBR 213, and the remote control device (and thus the user) would not have to access or interact with the WAT 200 directly. Thus line-of-sight or wireless communication access to the WAT 200 would not be required, and the WAT 200 may be placed in a more convenient location, such as a location selected for its proximity to the OTA television antenna 221.

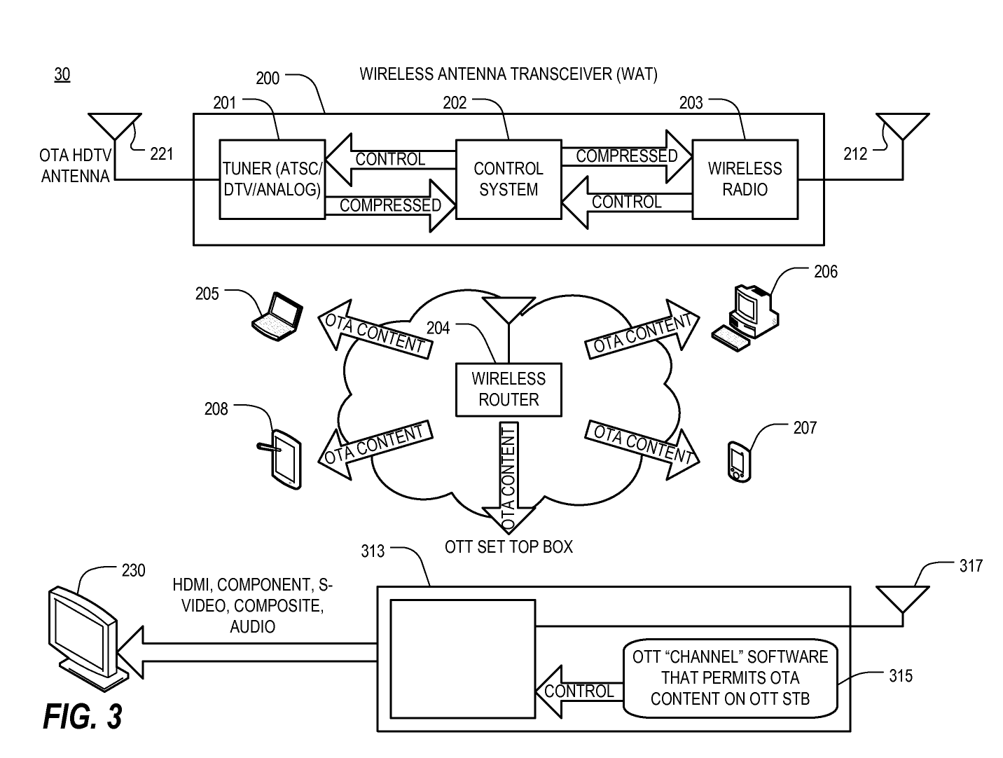

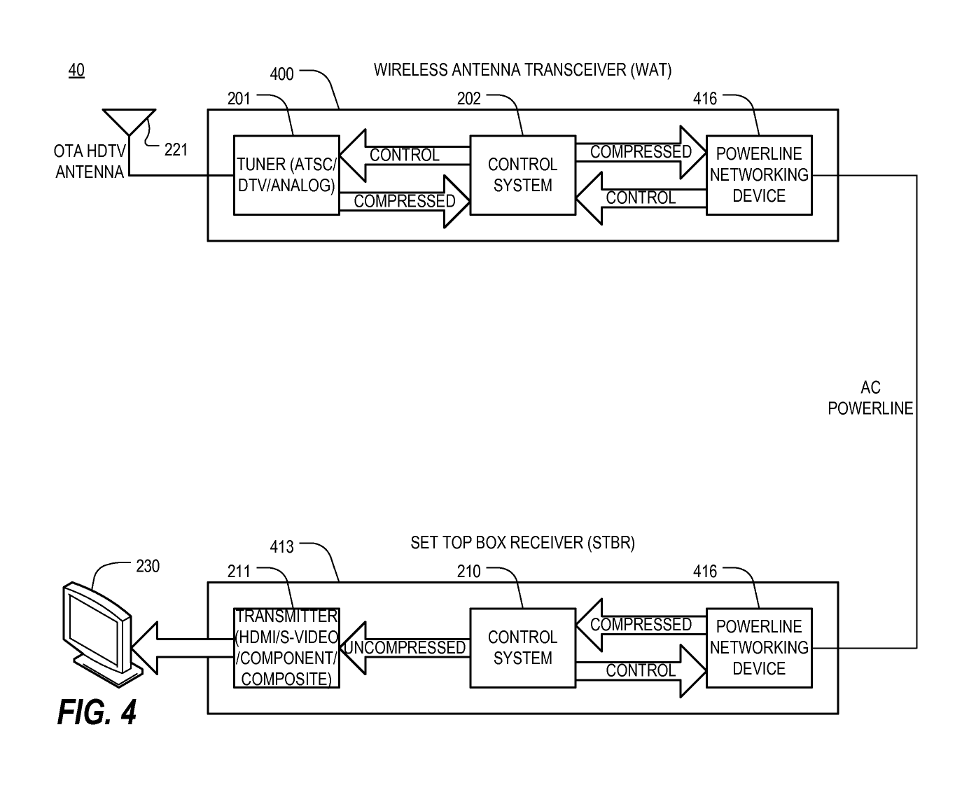

FIG. 3 is a block diagram illustrating a system 30 for the distribution of OTA television content to a remotely-located over-the-top set-top box 313 for display on a television receiver 230 in accordance with a second preferred embodiment of the present invention. In the system 30 illustrated in FIG. 3, the Wireless Antenna Transceiver (WAT) 200 communicates with an OTT Set-Top Box (STB) 313 over a wireless network. In at least some embodiments, the OTT STB 313 includes a Wireless Access Point that includes an antenna 317 and wireless radio (not shown). In particular, the Wireless Antenna Transceiver (WAT) 200 communicates with OTA “Channel” software 315 that permits OTA content to appear as a channel or feed on the OEM OTT Set-Top Box (STB) 313. Examples of such OEM STBs may include devices such as Roku®, Channel Master®, Amino®, and others. The “Channel” software 315 is generally proprietary software, provided by the OTT STB manufacturer, that takes the video feed and presents it as a channel or feed that the user can select to view. In this embodiment, the wireless signal from the WAT 200 may be routed over wireless link either directly, or via a wireless router 204, to the OTT STB 313. (If the STB 313 does not itself have wireless capability, then it can be connected to the wireless router 204 through an available physical port for a wired network connection, thereby allowing it to connect to the WAT 200.)

The OTT STB 313 is designed to stream video via a network connection from remote servers, but with appropriate application software 315, the OTT STB 313 can handle the OTA data stream from the WAT 200 in a manner similar to that used to stream from remote servers. In essence, the WAT 200 appears and functions like a remote video server to the OTT STB 313 when the latter is running the appropriate application. The resulting content may then be provided to a television in any appropriate format, such as HDMI, component audio and video, S-video, composite video, or the like. As with the system of FIG. 2, a user interface, controllable with a remote control device (not shown), may be utilized to effectuate control of the tuner 201 in the WAT 200 by relaying control messages back through the wireless network.

FIG. 4 is a block diagram illustrating: a system 40 for the distribution of OTA television content to a remotely-located set-top box receiver 413 for display on a television receiver 230 in accordance with a third preferred embodiment of the present invention, in the system 40 illustrated in FIG. 4, the Wireless Antenna Transceiver (WAT) 400 communicates with a Set-Top Box Receiver (STBR) 413 using “Ethernet over Powerline” or “power-line networking.” In this embodiment, the RF or other wireless communications link between the WAT 400 and STBR 413 is replaced by a communications link using power-line networking. As is widely known, power-line networking uses a building's existing electrical wiring to carry data signals as a replacement for over-the-air and dedicated wired communications. To facilitate this embodiment of the present invention, the WAT 400 and STBR 413 each include a corresponding power-line networking device 416 instead of a wireless radio. The rest of the Wireless Antenna Transceiver 400 is similar to the Wireless Antenna Transceiver 200 of FIG. 2, and the rest of the Set-Top Box Receiver 413 is similar to the Set-Top Box Receiver 213 of FIG. 2. The resulting content may then be provided to a television 230 in any appropriate format, such as HDMI, component audio and video, S-video, composite video, or the like.

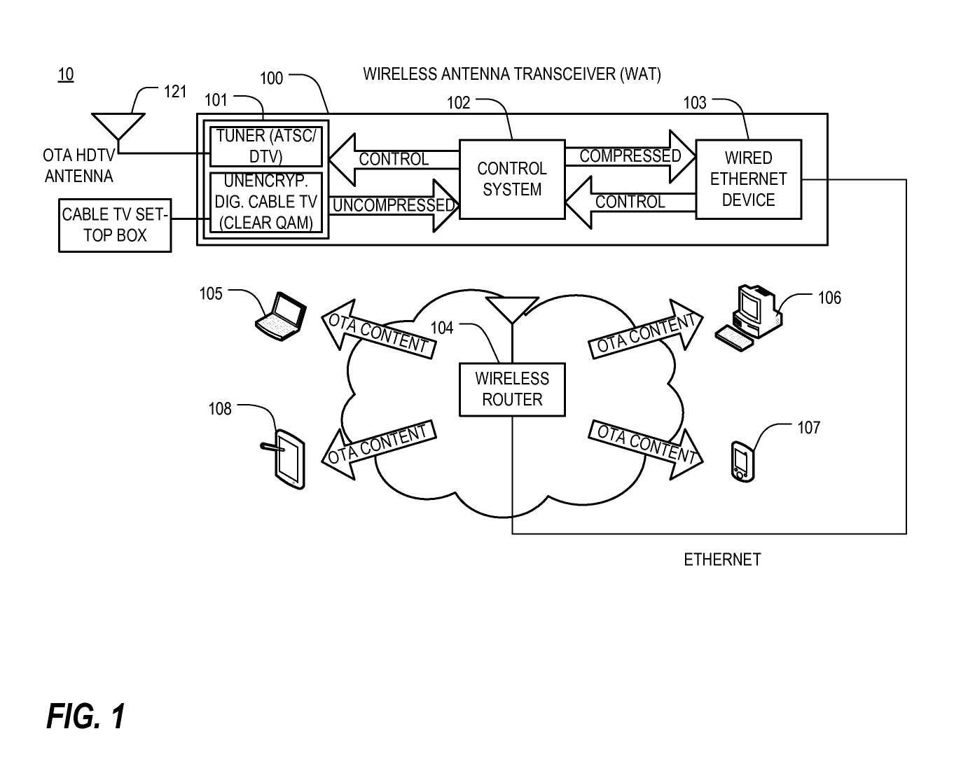

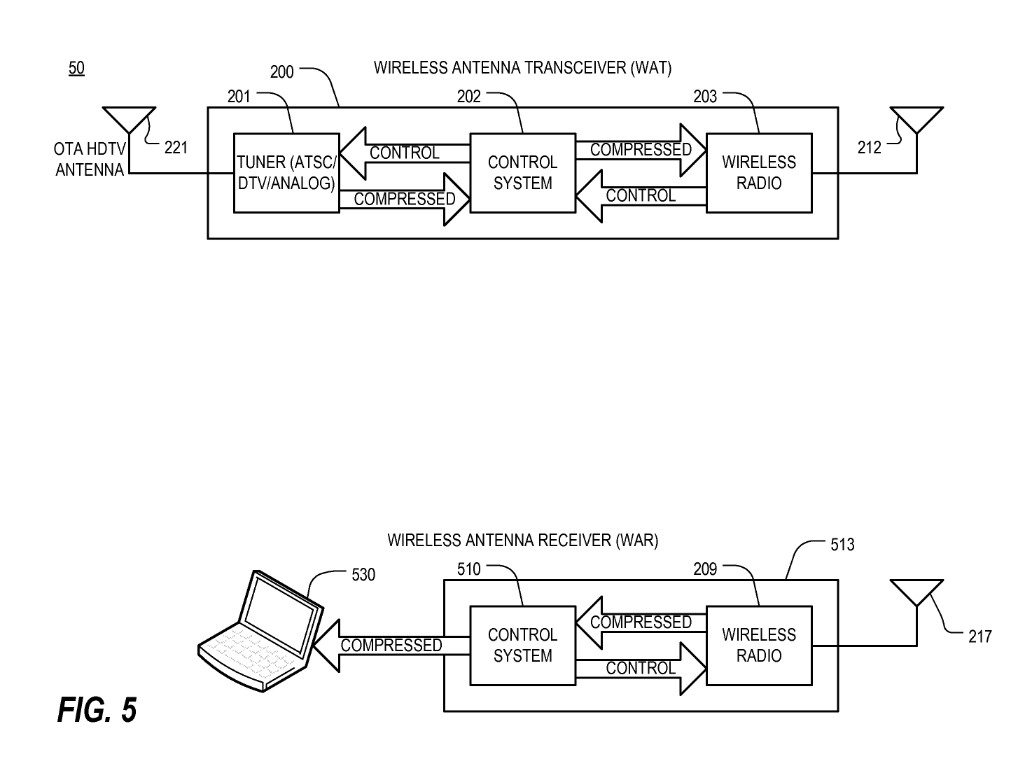

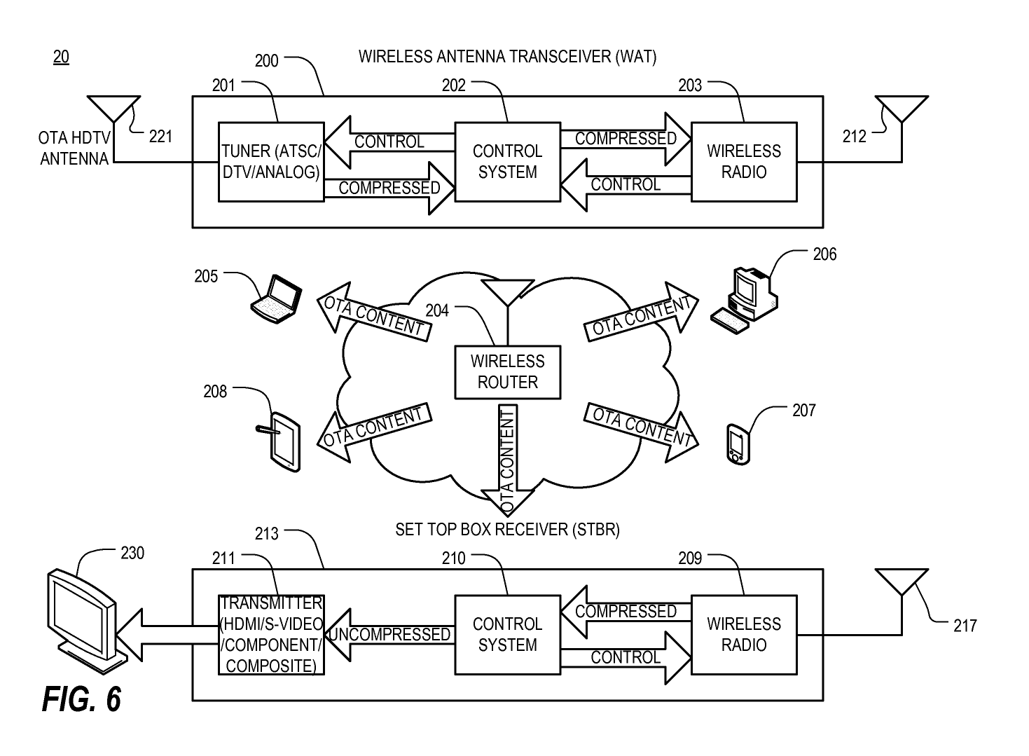

FIG. 5 is a block diagram illustrating a system 50 for the distribution of OTA television content to a remotely-located wireless antenna receiver 513 for display on a display device 530 in accordance with a fourth preferred embodiment of the present invention. In the system 50 illustrated in FIG. 5, the Wireless Antenna Transceiver (WAT) 200 communicates over a wireless link with a Wireless Antenna Receiver (WAR) 513 that feeds compressed video to a computer or other display device 530, where it is decoded to a common data format such as MPEG-4 or the like. In this embodiment, the Wireless Antenna Receiver (WAR) 513 receives the signal from the WAT 200 in similar fashion to the STBR 213 of FIG. 1, and the digital video signal is processed by the control system 510 to reassemble it into the OTA original video signal. However, unlike the other embodiments, the decompression of the video signal and other processing needed for display is performed in or at the display device 530, which may typically be a computer or other platform with sufficient processing capability, rather than in a STBR control system such as STBR 413 as shown in FIG. 4. Depending on the wireless communication format and protocol used, a peer-to-peer (P2P) network connection may be made by a wireless link to directly connect the WAT 200 to the WAR 513. The streaming content in this embodiment would be transmitted in a standard format, such as MPEG-4, and the display device 530 would require software to decode and play such formatted content such as Windows Media Player, Real Player, and the like. In a further variation of this embodiment, the functions performed by the WAR 513 are embodied in the display device 530, such as a laptop computer.

FIG. 6 is a block diagram illustrating a variation of the system 20 of FIG. 2 for the distribution of OTA television content for display on a display device in accordance with a fifth preferred embodiment of the present invention. In the variation of system 20 illustrated in FIG. 6, the Wireless Antenna Transceiver (WAT) 200 communicates with a Set-Top Box Receiver (STBR) 213 over a wireless network that includes a wireless router 204. As with other systems described herein, the Wireless Antenna Transceiver (WAT) 200 includes one or more tuners 201 capable of tuning analog or digital TV broadcast signals received over-the-air via an OTA television antenna 221. The tuners 201 demodulate the OTA signal and provide a compressed video signal output. The video signals from the tuners 201 are processed by the control system 202 which is responsible for controlling the tuners 201 as well as processing the compressed video (possibly including additional compression) to prepare it for transmission, over a wireless link, by the Wireless Access Point (wireless radio 203 and antenna 212). This may include compressing the video and packetizing the data among other functions. The video data is transmitted by the Wireless Access Point which may utilize any type or number of RF protocols and formats. These protocols and formats may include standard protocols such as 802.xx or ultra-wide band (UWB), but may also include proprietary formats and protocols.

From the wireless router 204, the video data can also be distributed to other devices, or multiple devices, linked to a wireless LAN, including laptops 205, desktop computers 206, handheld devices such as smartphones 207 and tablets 208, and the like. Depending on the wireless communication format and protocol used, a peer-to-peer (P2P) network connection may be made by a wireless link to directly connect the WAT 200 to a target display device such as laptops 205, desktop computers 206, handheld devices such as smartphones 207 and tablets 208, and the like.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is claimed is:

1. A system for the distribution of over-the-air (OTA) television content to a remotely-located set-top box receiver for display on a television receiver, comprising:
(a) an OTA antenna;
(b) a wireless antenna transceiver connected to the OTA antenna for receipt of OTA television signals via the OTA antenna, the wireless antenna transceiver including a first wireless access point for transmission of television content signals, derived from the OTA television signals, via wireless link:
(c) a set-top box receiver having a second wireless access point for receipt of television content signals via wireless link; and
(d) a television receiver connected to the set-top box receiver and adapted to receive video data therefrom based on the television signals received by the set-top box receiver via wireless link.

2. The system of claim 1, wherein the wireless link over which the first wireless access point transmits television content signals is the same wireless link with which the second wireless access point receives television content signals.

3. The system of claim 1, further comprising a wireless router, wherein the wireless link over which the first wireless access point transmits television content signals is a first wireless link, wherein the wireless router receives the television content signals transmitted by the first the wireless access point via the first wireless link, and wherein the second wireless access point receives television content signals via a second wireless link established between the second wireless access point and the wireless router.

4. The system of claim 1, wherein the wireless antenna transceiver further includes a tuner, adapted to tune analog or digital TV broadcast signals received over-the-air via the OTA antenna, and a control system, adapted to process a compressed video signal output from the tuner and to prepare it for transmission by the first wireless access point.

5. The system of claim 4, wherein the processing of the compressed video signal output by the control system includes further compression thereof.

6. The system of claim 4, wherein the processing of the compressed video signal output by the control system includes packetizing thereof.

7. The system of claim 1, wherein the first wireless access point transmits the television content signals using an 802.xx protocol wireless link.

8. The system of claim 1, wherein the second wireless access point receives the television content signals using an 802.xx protocol wireless link.

9. The system of claim 1, wherein the set-top box receiver further includes a transmitter, adapted to provide the video data to the television receiver, and a control system, adapted to uncompress the television content signals received by the second wireless access point.

10. The system of claim 1, wherein the television receiver is located in a room in a building, and wherein the wireless antenna transceiver is not located in the room.

11. The system of claim 1, wherein the set-top box receiver is located in a room in a building, and wherein the wireless antenna transceiver is not located in the room.

12. The system of claim 1, wherein the wireless antenna transceiver is located adjacent the OTA antenna.

13. A system for the distribution of over-the-air (OTA) television content to a remotely-located over-the-top set-top box for display on a television receiver, comprising:
(a) an OTA antenna;
(b) a wireless antenna transceiver connected to the OTA antenna for receipt of OTA television signals via the OTA antenna, the wireless antenna transceiver including a first wireless access point for transmission of television content signals, derived from the OTA television signals, via wireless link;
(c) an over-the-top set-top box having, a second wireless access point for receipt of television content signals via wireless link: and
(d) a television receiver connected to the over-the-top set-top box and adapted to receive video data therefrom based an the television signals received by the over-the-top set-top box via wireless link.

14. The system of claim 13, wherein the wireless link over which the first wireless access point transmits television content signals is the same wireless link with which the second wireless access point receives television content signals.

15. The system of claim 13, further comprising a wireless router, wherein the wireless link over which the first wireless access point transmits television content signals is a first wireless link, wherein the wireless router receives the television content signals transmitted by the first the wireless access point via the first wireless link, and wherein the second wireless access point receives television content signals via a second wireless link established between the second wireless access point and the wireless router.

16. The system of claim 13, wherein the wireless antenna transceiver further includes a tuner, adapted to tune analog or digital TV broadcast signals received over-the-air via the OTA antenna, and a control system, adapted to process a compressed video signal output from the tuner and to prepare it for transmission by the first wireless access point.

17. The system of claim 16, wherein the processing of the compressed video signal output by the control system includes further compression thereof.

18. The system of claim 16, wherein the processing of the compressed video signal output by the control system includes packetizing thereof.

19. The system of claim 13, wherein the first wireless access point transmits the television content signals using an 802.xx protocol wireless link.

20. The system of claim 13, wherein the second wireless access point receives the television content signals using an 802.xx protocol wireless link.

21. The system of claim 13, wherein the over-the-top set-top box is adapted to provide the television content signals, received by the second wireless access point, as a content channel that is selectable by a user of the over-the-top set-top box, and to provide the video data to the television receiver when the content channel is selected.

22. The system of claim 13, wherein the television receiver is located in a room in a building, and wherein the wireless antenna transceiver is not located in the room.

23. The system of claim 13, wherein the over-the-top set-top box is located in a room in a building, and wherein the wireless antenna transceiver is not located in the room.

24. The system of claim 13, wherein the wireless antenna transceiver is located adjacent the OTA antenna.

25. A system for the distribution of over-the-air (OTA) television content to a remotely-located set-top box receiver for display on a television receiver, comprising:
(a) an OTA antenna;
(b) a wireless antenna transceiver connected to the OTA antenna for receipt of OTA television signals via the OTA antenna, the wireless antenna transceiver including a first power-line networking device for transmission of television content signals, derived from the OTA television signals, via power-line networking;
(c) a set-top box receiver having a second power-line networking device for receipt of television content signals via power-line networking; and
(d) a television receiver connected to the set-top box receiver and adapted to receive video data therefrom based on the television signals received, by the set-top box receiver via power-line networking.

26. The system of claim 25, wherein the wireless antenna transceiver further includes a tuner, adapted to tune analog or digital TV broadcast signals received over-the-air via the OTA antenna, and a control system, adapted to process a compressed video signal output from the tuner and to prepare it for transmission by the first power-line networking device.

27. The system of claim 26, wherein the processing of the compressed video signal output by the control system includes further compression thereof.

28. The system of claim 26, wherein the processing of the compressed video signal output by the control system includes packetizing thereof.

29. The system of claim 25, wherein the set-top box receiver further includes a transmitter, adapted to provide the video data to the television receiver, and a control system, adapted to uncompress the television content signals received by the second power-line networking device.

30. The system of claim 25, wherein the television receiver is located in a room in a budding, and wherein the wireless antenna transceiver is not located in the room.

31. The system of claim 25, wherein the set-top box receiver is located in a room in a building, and wherein the wireless antenna transceiver is not located in the room.

32. The system of claim 25, wherein the wireless antenna transceiver is located adjacent the OTA antenna.
